(19) United States
(12) Patent Application Publication
(10) Pub. No.: US 2013/0333270 A1
(43) Pub. Date: Dec. 19, 2013

(54) Multiple Mode Artificial Fishing Lure

(71) Applicant: Robert Castaneda, San Antonio, TX (US)

(72) Inventor: Robert Castaneda, San Antonio, TX (US)

(21) Appl. No.: 13/920,786

(22) Filed: Jun. 18, 2013

Related U.S. Application Data
(60) Provisional application No. 61/660,898, filed on Jun. 18, 2012.

(51) Int. Cl. A01K 85/01

(52) U.S. Cl. CPC A01K 85/01
USPC 43/17.6; 43/42.31

(57) ABSTRACT

An aquatic life simulation apparatus and system capable of reading the environmental conditions of the water and configured to modify apparatus' behavioral characteristics based on the recorded data. The apparatus contains a waterproof component having a controller operationally coupled to a sound producing chip having pre-recorded bait fish sounds recorded thereon; a speaker to broadcast said recorded sounds; and a sensor for detecting dynamic movements. The sound chip may be activated upon impact of the apparatus with a body of water and repeat various desired patterns thereafter. Embodiments of the present apparatus contain LED in the eye members and along the body of the lure. The apparatus is configured to communicate with surface electronic devices capable of changing various characteristics of the apparatus based on the changes in the environmental conditions of the water.

### CROSS-REFERENCE TO RELATED APPLICATIONS/PATENTS

This U.S. Utility Application claims priority pursuant to 35 U.S.C. §119(e) to the following U.S. Provisional Patent Application, the specification of which is incorporated herein by reference for all purposes: U.S. Provisional Application Ser. No. 61/660,898, titled “Multiple Mode Artificial Fishing Lure,” filed Jun. 18, 2012, pending.

### TECHNICAL FIELD

The present invention generally relates to an aquatic life simulation apparatus and system capable of reading the environmental conditions of the water and configured to modify the apparatus' behavioral characteristics based on the recorded data. More specifically, the present invention relates to an aquatic life simulation apparatus and system designed to closely replicate the behavior of live bait species and other aquatic species, both with regard to physical appearances and sound patterns, and to communicate with surface electronic devices capable of changing various characteristics of the apparatus based on the changes in the environmental conditions of the water.

### BACKGROUND OF THE INVENTION

Early on, mankind relied on fishing as a means of survival; however, over the years fishing has evolved from solely a means of survival to a sport. And, while the reasons for fishing itself have changed, so have the methods employed. While the first fisherman may have relied on rudimentary spears, nets, or even their bare hands to capture fish-today anglers heavily rely on live bait or artificial lures.

There is a variety of live bait available for use, and even a much wider array of surprisingly sophisticated fishing lures available to bolster the success of any fisherman. These lures come in a surprisingly wide variety of shapes, sizes, and colors. This, in part, is a result of the fact that each size, shape, and color scheme of a particular lure strongly affects the success or failure of a fisherman under particular conditions. For example, a lure having reflective properties may be particularly useful for top water use on a sunny day. That is, as the lure is reeled in it will shimmer in the sun in a manner to attract surrounding fish.

An overwhelming majority of anglers agree in one very important aspect—artificial lures are far superior in catching fish and ease of use when compared to natural bait. It is estimated that out of all the professional or semi professional fish anglers, ninety percent prefer the use of artificial lures over live bait. Such is the result for several reasons. Artificial lures can be easily switched out with one another to maximize productivity according to changing conditions. Also, artificial lures are generally cheaper than live bait. Finally, artificial lures are extremely durable—they can be used over and over again, while live bait obviously has a short operating life.

The development of better lures is further spurred on by the ever-increasing popularity of fishing as a sport. In fact, there is constantly growing number of publications dedicated to the sport of fishing. Moreover, it is not uncommon to come across television programming dedicated solely to fishing. In light of the growing popularity of the sport, and the endless combinations for lure design, a tremendous amount of time and effort is devoted to producing the very best lure. It is not uncommon for a company to spend several thousands of dollars on the research and development of a single artificial lure alone.

Despite the tremendous variety in available lures and their technological advances in recent years, all currently available lures are limited in view of Applicant's invention. That is, while a staggering amount of time and effort has been dedicated to developing the most effective size, shape, and color combination for particular lures, each of these lures lacks an important dimension provided by the present apparatus.

Applicant's invention provides an artificial lure that may be configured to have an effective appearance and produce acoustical signals to entice surrounding fish. Such acoustical signals alert fish to the lure and help the fish determine lure location. Finally, embodiments of the lure are equipped with a programmable controller and are capable of mimicking specific live bait species.

In view of the limitations associated with available lures, mostly their inability to produce acoustical signals and resulting limited ability to attract fish, a great need exists for an artificial lure that offers the same benefits as available lures and additionally attracts fish via acoustical signal patterns. Applicant's invention, as will be fully discussed in the specification to follow, through its numerous embodiments, provides such a lure. More specifically, the present invention provides a lure that is capable of attracting fish through both sight and sound.

Applicant's invention provides an alternative to particular types of bait. One such type of bait the current invention replaces is that of the “croaking” bait, or “croaker” fish. Currently, the only option a fisherman has when using Croaker fish as bait is to purchase actual, live bait. Typically, these types of bait are purchased by a standard size bucket-full at a cost of approximately twenty dollars per bucket. With typical use, a bucket-full of such bait lasts about a half day. As such, a full day of fishing while using this type of bait costs approximately forty dollars for bait alone. On the other hand, the cost associated with the present invention is approximately nine dollars for months or even years of use.

Benefits associated with the present invention include use of a lure that is the product of a sound engineering and manufacturing processes. Also, the current invention is associated with the highest quality units of production, several available feature combinations, and relatively straightforward and efficient manufacturing process. Moreover, the invention has near perfect acoustic rhythm and is capable of reproducing the behavioral characteristics of the specific species of which it is to simulate. Such is the result as the apparatus of the present invention is designed to be extremely precise in duplicating bait species movement and sound as it is being reeled in. Particular versions of the present invention will provide a lure having sound emitting qualities. Other versions will also contain the Light-emitting diode (LED) as eye members and LED along the lure body to simulate the natural sun light reflecting from the scales of a bait species.

Another useful need served by Applicant's invention comes within the realm of aquatic life observation. That is, particular embodiments of the present invention are equipped with a sound chip capable of accurately replicating the acoustical patterns of various aquatic species of interest. As such, both the simulated species and surrounding species may be observed in their natural state more easily.

### SUMMARY OF THE INVENTION

It is an object of the present invention to provide an aquatic life simulation apparatus that closely replicates the behavior of any number of predetermined aquatic species.

It is another object of the present invention to provide an aquatic life simulation apparatus having a speaker.

It is another object of the present invention to provide an aquatic life simulation apparatus capable of producing various acoustical patterns.

It is another object of the present invention to provide an aquatic life simulation apparatus that may activate upon contact with a body of water.

It is another object of the present invention to provide an aquatic life simulation apparatus that is extremely durable.

It is another object of the present invention to provide an aquatic life simulation apparatus that is cost effective.

It is another object of the present invention to provide an aquatic life simulation apparatus that emits light from its body.

It is another object of the present invention to provide an aquatic life simulation apparatus that emits light from its eyes.

It is another object of the present invention to provide an aquatic life simulation apparatus that reads environmental conditions of the water.

It is another object of the present invention to provide an aquatic life simulation apparatus that communicates with surface electronic devices configured to change various characteristics of the apparatus based on the changes in the environmental conditions of the water.

In view of the foregoing and other related objectives, Applicant's invention provides a highly innovative aquatic life simulation apparatus. Most embodiments, generally, have a very soft and durable exterior body and are air brushed to the likeness of a particular species. That is, the air brush finish adds detail to the apparatus so that it can take on several appearances—any of which can be selected according to conditions and desires.

Perhaps the most novel feature of the claimed invention is its inner capsule and combination of components contained therein. In most preferred forms, the inner capsule is waterproof and contains a “sound chip,” capable of producing acoustical patterns very closely resembling those of any number of aquatic species. The desired result may be to entice surrounding fish or simply to replicate a particular species within its natural environment. In the preferred form, this sound chip is operationally coupled with a power source and a speaker. Remarkably, this sound chip is embedded with acoustical information associated with any number of specific aquatic species.

Further, the sound chip may be programmed to begin its acoustical pattern as soon as the apparatus makes contact with the water. This is accomplished as the sound chip may be further coupled to a motion sensor and configured to activate upon contact with water or relative motion of the apparatus.

As mentioned, the sound chip may receive and perform several distinct acoustical patterns, and in one preferred form, the apparatus of the present invention will be able to accurately reproduce the sounds and movements associated with creatures eaten by game fish. For example, a particularly effective embodiment of the present invention is capable of performing the sound and pattern of “croaking” associated with species commonly preyed upon by game fish. By way of further example, the sound chip may repeat a pattern where it emits acoustical signals for a period of time and then remains dormant for the same period of time. Such a pattern may be preferred in that it allows for the “jerk and reel” procedure commonly preferred by fisherman.

Certain embodiments of the present invention include other novel features such as realistic appearing eyes and body members. That is, these embodiments include LEDs throughout the apparatus eye and along the body. Such characteristic is particularly useful in replicating the effect of the sun reflecting from aquatic life.

Other embodiments of the present invention allow the apparatus to acquire data relating to environmental conditions of fish habitats. The apparatus contains instrumentation that can record pressure, temperature, turbidity, and pH levels among others. The apparatus further contains algorithms to modify the acoustical patterns emitted based on the recorded data. The color and frequency of the light emitted from the LEDs is determined by algorithms based on the data collected by the apparatus.

Another novel feature of the invention allows the apparatus to communicate with electronic devices such as onboard computers, depth finders, tablets, hand-held PDAs and smart phones. These embodiments include wireless communication hardware, such as WiFi, Bluetooth, or radio frequency antennas. A custom application is loaded onto personal electronic devices that are programmed to receive recorded data through similar wireless communication hardware. The application also allows the user to send commands to the apparatus to modify acoustical patterns and LED performance.

### BRIEF DESCRIPTION OF THE DRAWINGS

FIG. 1 is a side view of the apparatus of the present invention.

FIG. 2 is a block diagram of one embodiment of the present invention capable of data acquisition and wireless communication.

FIG. 3 displays the internal components, sensors, and processors of one embodiment of the present invention.

FIG. 4 displays the functions of the custom application device used in one embodiment of the present invention.

FIG. 5 displays the communication between the custom application, device, and the lure.

FIG. 6 displays the data interaction between the custom application and the lure.

FIG. 7 displays the communication between the custom application and the lure.

FIG. 8 displays other uses for the custom application and device according to one embodiment of the present invention.

FIG. 9 displays the data exchange between the custom application and an alternative Sports Aquatic Marine Instruments (SAMI) units.

FIG. 10 displays communications between the custom application and multiple SAMI devices, including the lure.

FIG. 11 displays the interaction between multiple SAMI devices while the lure is in the water.

### DETAILED DESCRIPTION OF THE INVENTION

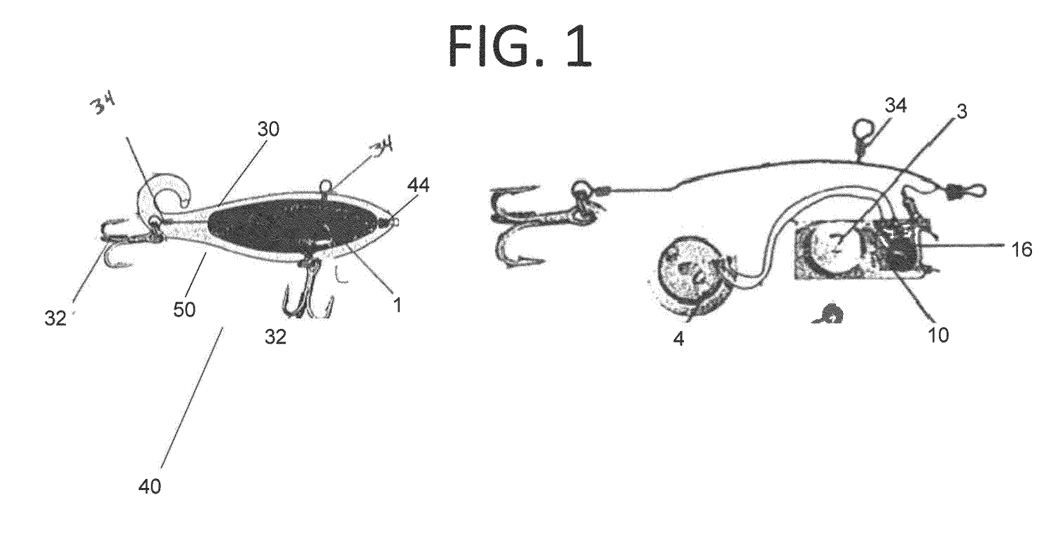

Referring to FIG. 1, the aquatic life simulation apparatus of the present invention is generally designated by numeral 40. Apparatus 40, in the preferred embodiment, is one of three primary colors: copper, bronze, or chrome. In addition, apparatus 40 may be finished with some material to further enhance the reflective value of apparatus 40. While the preferred embodiment is thought to be most beneficial when having a metallic-type finish as mentioned above, other useful embodiments are envisioned where apparatus 40 may be of other color scheme. For instance, a neon color combination scheme is thought to be particularly useful for attracting fish under certain conditions.

Apparatus 40 is characterized by inner capsule 1. In the preferred embodiment, inner capsule 1 houses and protects speaker 4, controller 10, battery 3, and motion sensor 16. Inner capsule 1 holds speaker 4, controller 10, battery 3, and motion sensor 16 in a water-free (waterproof) environment, and further acts as an impact absorbing means for these components. As such, the components contained within capsule 1 are protected from both water and incident forces by virtue of being contained within capsule 1.

In the preferred embodiment, inner capsule 1 may be primarily composed of rubber, plastic, fiberglass, or some combination thereof. Other embodiments are particularly useful if speaker 4 is not housed within capsule 1, but is adjacent to capsule 1 (not shown) and remains in combination with the other referenced components contained with capsule 1. In such embodiments, speaker 4 is a water-resistant or waterproof speaker appropriately sized to fit within apparatus 40. Such speaker members are known, and will be apparent to those skilled in the art.

As mentioned, operation of apparatus 40 involves the components housed within capsule 1. Upon some trigger event, such as impact with water or relative motion of apparatus 40, controller 10 performs according to its stored programming. That is, embodiments are envisioned where controller 10 is operationally coupled with motion sensor 16. In such embodiments, motion sensor 16 reacts to changes in velocity of apparatus 40. Upon sufficient reaction, motion sensor 16 signals controller 10 to initiate performance. Controller 10 then acts according to the reaction of motion sensor 16. This action may be carried out for a determined time and then cease, or continue in repeated fashion. Finally, one of the most novel aspects of the present invention is the ability of controller 10 to accurately and precisely replicate the acoustical patterns of a variety of aquatic life. This replication is carried out according to stored programming of controller 10.

Controller 10 is further operationally coupled with, and powered by, battery 3. In the preferred embodiment, battery 3 is a relatively small, low voltage battery. Such is preferred as the target weight of apparatus 40 is less than approximately one half ounce.

Controller 10 is electronically coupled with speaker 4, where speaker 4 emits acoustical patterns according to signals received from controller 10. In the preferred embodiment, speaker 4 is of a “micro speaker” variety as known to those skilled in the art, typically having a diameter of approximately less than one inch.

Other useful embodiments are envisioned where some light emitting means, such as a series of light emitting diodes (LED), is further in combination with controller 10. In such embodiments, the LEDs are activated upon signals received from controller 10. The most beneficial arrangement of such light emitting means is envisioned where LEDs are dispersed along the peripheral body of apparatus 40 and/or placed as eye members. Such arrangement is thought to be most beneficial in simulating real-life behavioral characteristics. However, the LED can be position in practically any part of the apparatus.

Apparatus 40 is further characterized by support member 30. In the preferred embodiment, support member 30 aligns with capsule 1 and is configured to ensure apparatus 40 remains engaged with a fishing line. Support member 30 imparts rigidity and strength to apparatus 40 and may be configured to directly receive and mate with a hook 32.

Support member 30 may also receive a hook connection means 34. Hook connection means 34 may be a fishing line of sufficient strength to withstand the force exerted by an expected fish snared by hook 32. In each of these embodiments, support member 30, in combination with hook 32, or in combination with both hook 32 and hook the connection means 34, provide a mechanism whereby a fish may take apparatus 40 within its mouth and then become snagged by hook 32. As the fish attempts to retreat, support member 30, hooks 32, and possibly hook connection means 34, hold the fish engaged with apparatus 40 while apparatus 40 remains secured to a fishing line. Finally, other useful embodiments are envisioned where capsule 1 is further configured to replace support member 30. That is, by ensuring capsule 1 is of sufficient strength, capsule 1 may directly receive and mate with hook 32 or hook connection means 34.

Apparatus 40 further has an outer member 50. Outer member 50 surrounds and substantially covers capsule 1 and support 30. Also, member 50 primarily provides apparatus 40 with its actual, final physical appearance. As such, in its most preferred form, member 50 is comprised mostly of plastic or rubber, or some composite thereof and finished with metallic-type appearing finish. Such a finish is particularly useful as it reflects sunlight to further attract predator attention. As mentioned, particularly useful embodiments are envisioned where outer member 50 contains LED or some other light-emitting means (such as micro-bulbs or fiber optics members) along its length and along eyes 44. Such embodiments, through their light emitting quality, and in combination with acoustical signals sent from apparatus 40, further attract the attention of surrounding fish.

Additional, alternative embodiments of the present invention include refinements and additions described hereafter.

Outer composite “body” capsule 50 is shaped in a way that can house all components and generate the pitch while being as hydro dynamically efficient as possible. Outer capsule 50 and equipment inside generate the same underwater hydro force as fish the same size as the apparatus 40.

Visual Stimulation Emitting Diodes (VSED) are, in some embodiments, placed inside eyes 44 of outer capsule 50. VSEDs have a recurring pattern of fading-in fading-out bright red, white, green or white and dark, and repeating with a predetermined time pattern. This process simulates that natural occurrence found in most species of fish called “flashing,” a natural occurrence of sunlight reflecting on the surface of fishes' eyes while traveling in the water at high speeds.

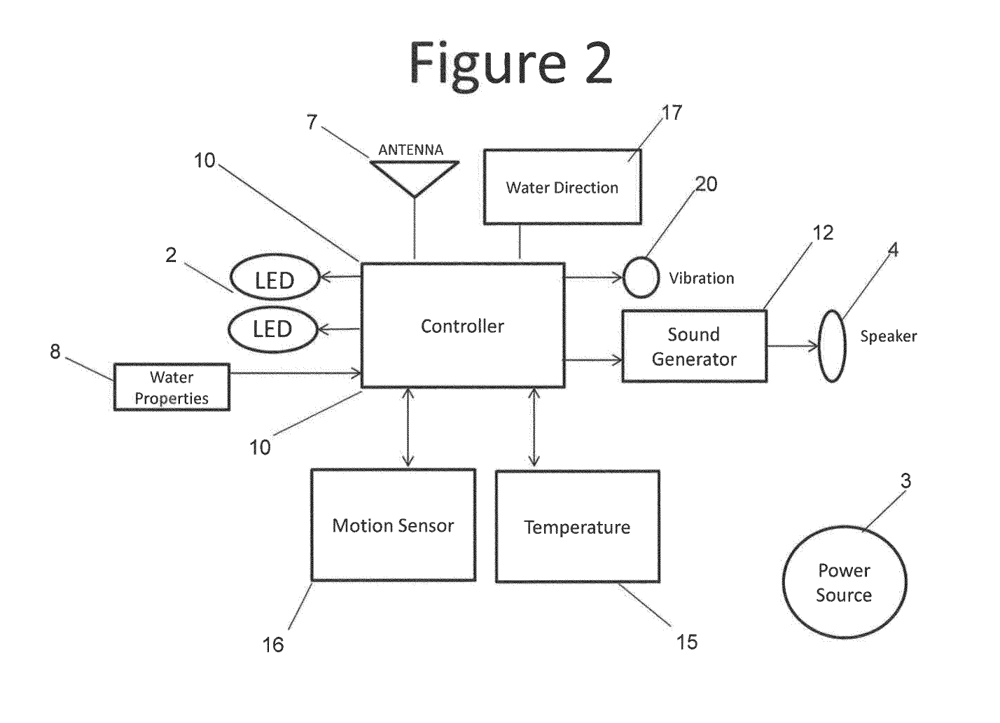

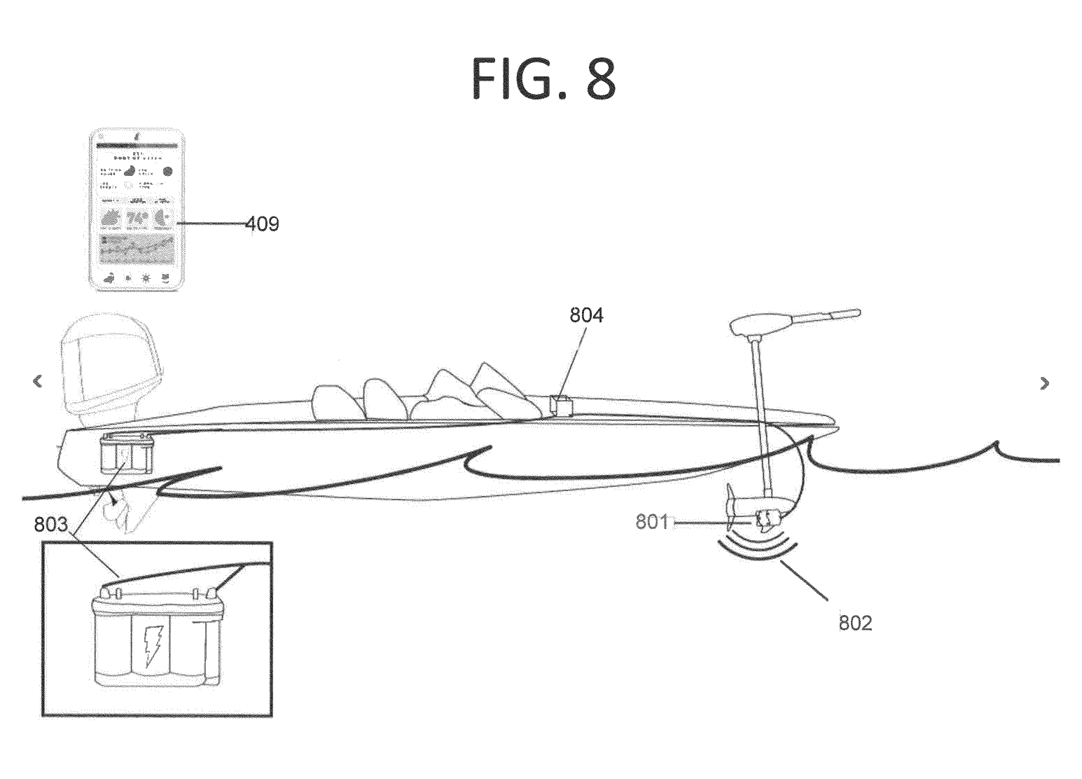

In some embodiments, controller 10 will communicate via wireless communication platforms with surface on-board computers, tablets, hand-held PDAs and smart phones to relay environmental, water and structural conditions of fish habitats. In these embodiments, controller 10 can be a Submersible Micro Integrated Circuit (SMIC) and maybe located either inside or outside the lure. For example SMIC can be located anywhere on the fishing boat as illustrated in FIG. 8 or above the pier, if the fishing is performed from it. FIG. 2 represents a block diagram of such an embodiment of the current invention. In this embodiment, apparatus 40 features speaker 4, controller 10, motion sensor 16, battery 3, water direction measurement system 17, antenna 7, at least one LED 2, water detection sensor 8, and temperature sensor 15. According to one embodiment of the present invention, the antenna 7 is 2.4 GHz antenna, the motion sensor 16 is a 3-axis accelerometer, the water detection sensor 8 is a micro fluidic sensor, and temperature sensor is a thermocouple or other temperature measuring device that is known to those skilled in the art.

In this embodiment, controller 10 can be triggered to perform in several ways. First, controller 10 can be triggered to perform as programmed when motion sensor 16 signals controller 10 that a sufficient change in velocity has occurred. Controller 10 adjusts the sound emitted from speaker 4 which, in turn, adjusts the vibration frequency 20 emitted from the speaker 4. Water detection sensor 8 can trigger the controller 10 when the apparatus enters the water. The user can also trigger controller 10 to perform through the antenna 7. It is envisioned that this embodiment will enable the user to control certain aspects of the apparatus through a custom application running on a personal electronic device. Thus, controller 10 can be triggered to perform as programmed by the user running the custom application. Once triggered, controller 10 can perform as programmed or until it receives a signal from antenna 7.

According to one embodiment of the present invention, once controller 10 is triggered, it acquires and transmits certain environmental conditions to the user via the antenna 7. Temperature sensor 15 sends water temperature to controller 10, while water direction system 17 acquires the velocity of the water. Based on these readings, controller 10 can perform automatically based on pre-programmed algorithms changing the characteristics of the apparatus. The readings will also be transmitted to the personal electronic device via antenna 7. In other embodiments, controller 10 acquires and logs other environmental conditions of the water, including turbidity, pH levels, plankton content, oxygen saturation, thermo cline readings and toxic levels within the habitat and surrounding areas.

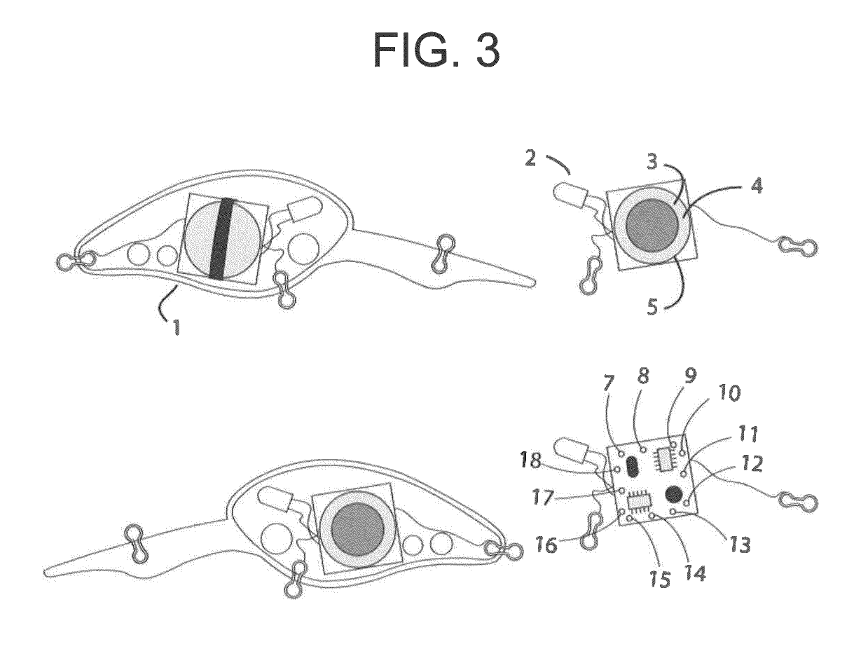

FIG. 3 displays a layout of the electronic circuit in inner capsule 1 of an embodiment with wireless capability. In this embodiment, wireless controller 10 communicates with the custom application through multiple wireless systems. First, controller 10 can send and receive data through standard WiFi 2.4 GHz antenna 7. According to one embodiment of the present invention, the controller 10 is also capable of communicating on lower frequency channels via 315 MHz antenna 13, 900 MHz antenna 18, and 1600 MHz antenna 9. Near field communication (NFC) and Bluetooth low energy (BLE) technologies are also wireless communications methods used by controller 10 via NFC antenna 11 and BLE antenna 14, respectively. The plurality of wireless systems used by controller 10 allows the custom application to be loaded and used on many different wireless platforms.

The user can modify the performance of the apparatus using a custom application loaded on an electronic device. It is envisioned that the electronic device will generate signals with a sound generator 12 according to the user's input that can be received by any of the wireless platforms included in capsule 1. The emission of the sound may be controlled by a sound emission control 5. The wireless platform relays these signals to controller 10. Controller 10 adjusts the sound emitted from speaker 4 which, in turn, adjusts the vibration frequency emitted from the speaker 14, or the light emitted from LED 2, or any combination thereof, based on the signals received from the user. According to one embodiment of the present invention, speaker 4 might be a metal and ceramic speaker of the PIEZO mark with vibrating capabilities when the sound is passing through it.

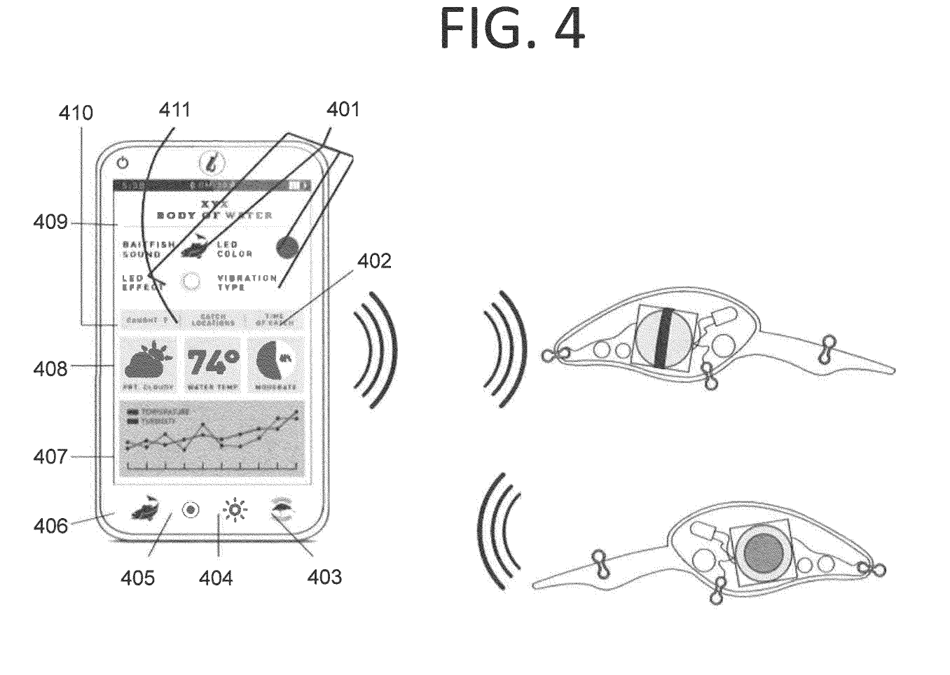

Turning to FIG. 4, the onboard equipment computers, tablets, handheld PDA's and smart phones can send commands to apparatus 40 via a custom application to change wave sound pitch, change frequency of VSED fading in and out and change color of VSED among others. The apparatus has the ability to be turned off or on via the application on devices smart phones, PDA's, PC, notebooks, tablets or on board computer. According to one embodiment of the present invention, the sound can be changed to a different sound or pitch and/or shut off completely, the LED can be changed to different colors or patterns and/or shut off completely. Different sounds, pitches, patterns in the emitted sound and LED lights patterns can be wirelessly uploaded to apparatus through application. This can also be done through micro, mini and full size USB jacks.

Custom application 409 features many functions. There are capacitive controls 401 that can be sent to the capsule. In the embodiment displayed in FIG. 4, custom application 409 controls the sound, LED color, LED effect, and vibration type of inner capsule 1. When the user desires to change the sound emitted from inner capsule 1, he can do so using sound emission control 403. LED control 404 allows the user to activate the LED and control the amount of light emitted. Type of illumination control 405 and type of fish sound control 406 are used to alter the type of illumination and the type of fish sound is emitted from inner capsule 1, respectively.

Controller 10 also, in some embodiments, has data acquisition capability. Custom application 409 displays the data stored by controller 10 in a user-friendly interface. The interface helps the user determine control settings. Water property readings 407 are displayed in graph form so the user can see changes in certain water properties over time. Environmental data readings 408 tell the user the conditions outside the water. Fish catching log 410 and time of catch 402 are also displayed.

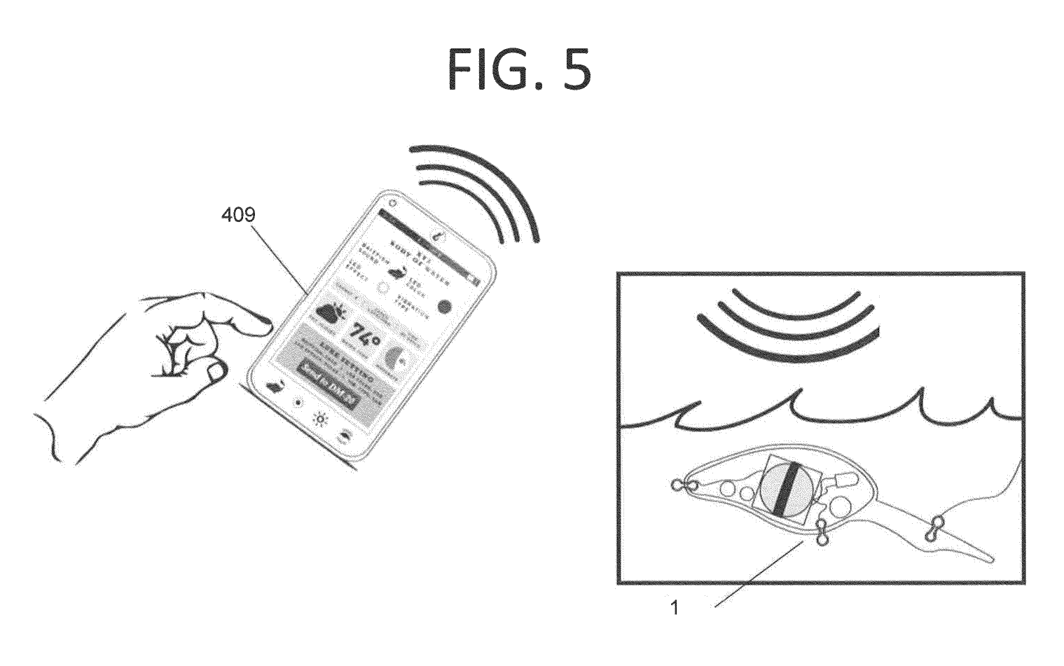

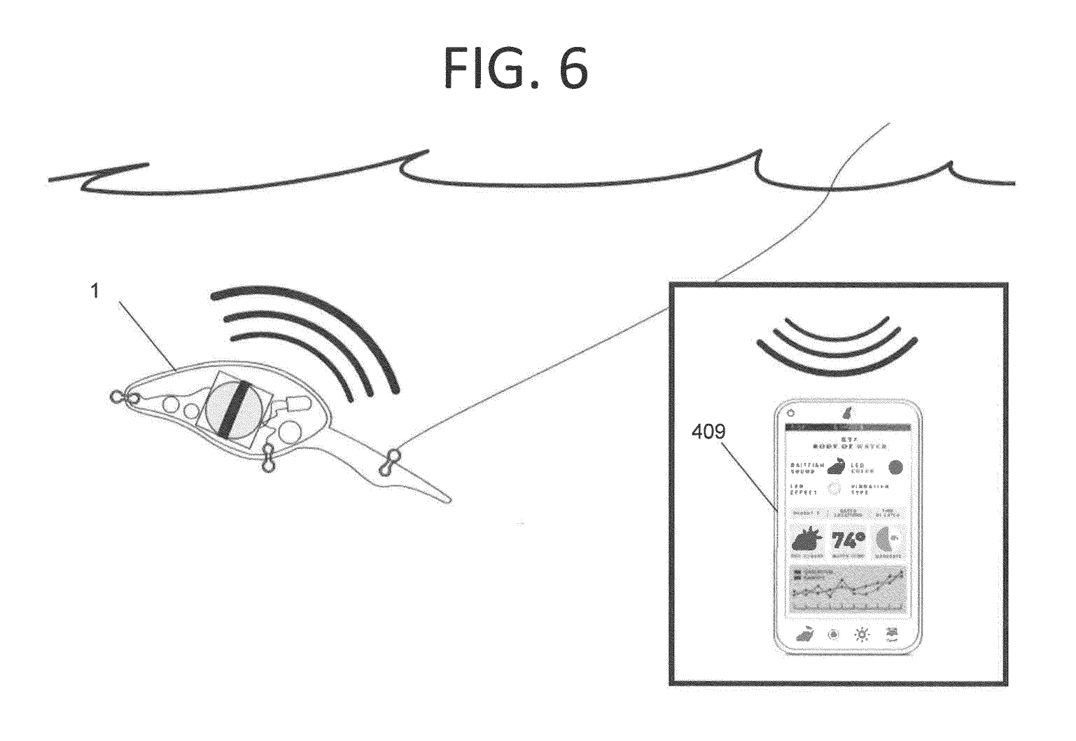

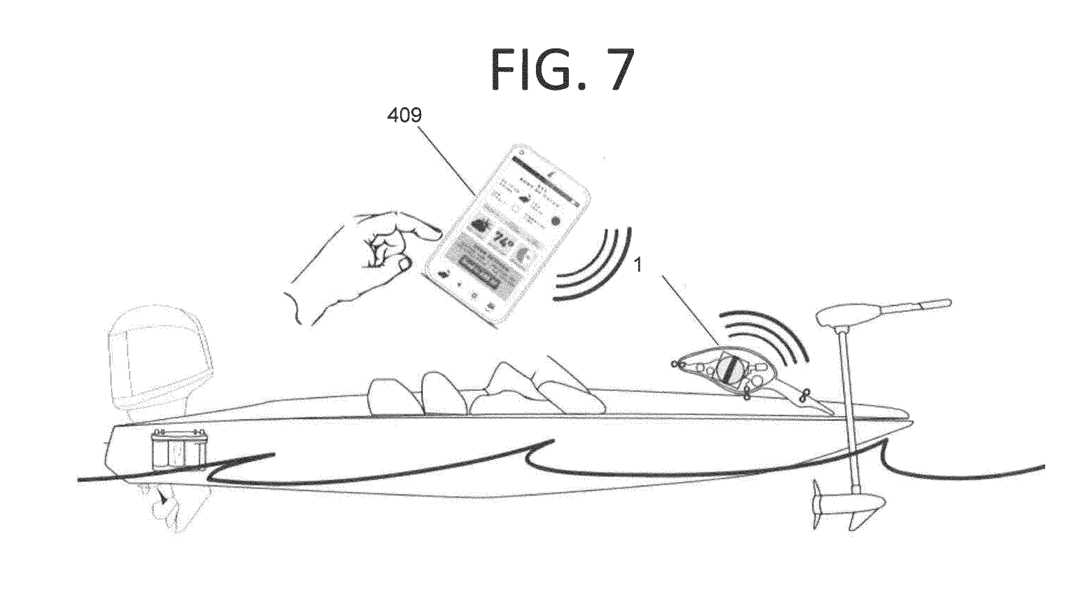

On a typical day out on the lake, the user begins by programming controller 10 via custom application 409 before inner capsule 1 is cast as shown in FIG. 5. Inner capsule 1 collects data while it is submerged. Once inner capsule 1 is pulled from the water, the data collected is transferred to custom application 409. Based on the data collected during the cast, the user can make changes to the settings before the next cast through custom application 409. While inner capsule 1 collects data while submerged, it cannot relay that data to custom application 409 until it is pulled from the water, as shown in FIG. 6. Custom application 409 logs the data from inner capsule 1 in real time once inner capsule 1 is out of the water as shown in FIG. 7. Data is exchanged between inner capsule 1 and custom application 409 each time inner capsule 1 exits the water.

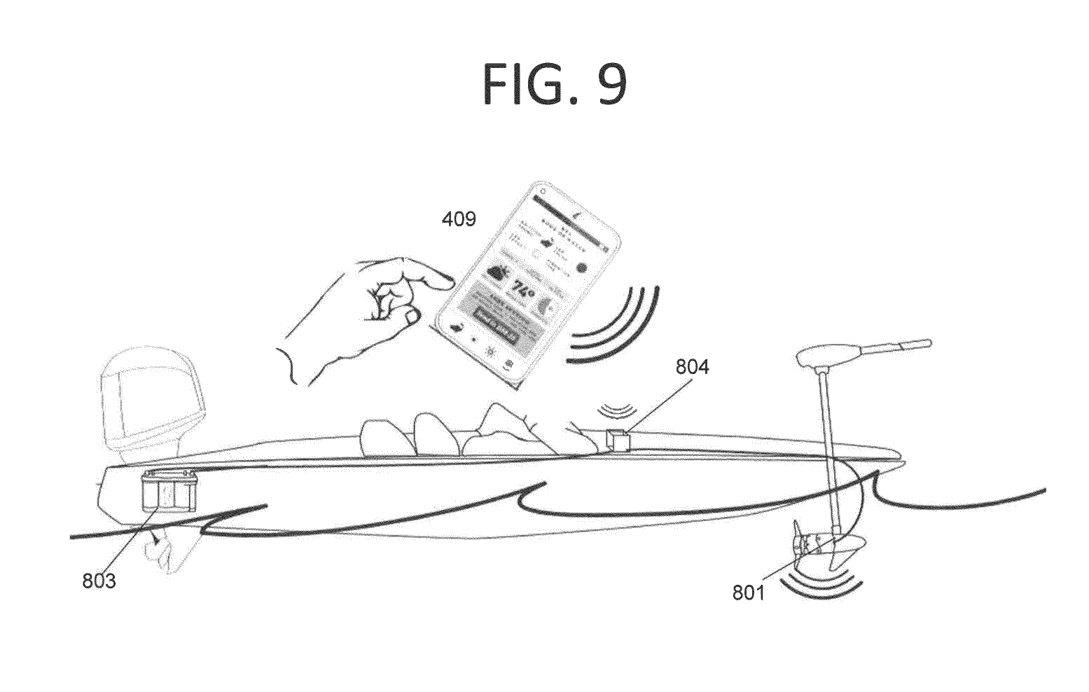

The current invention can be used alongside other Sports Aquatic Marine Instruments (S.A.M.I.) as shown in FIG. 8. Underwater unit 801 is attached to the boat such that it is submerged the entire time the boat is in the water. Underwater unit 801 takes water property readings continuously including turbidity, pH level, and water clarity. Underwater unit 801 is connected via cable to on board control unit 804 which enables constant relay of the data from underwater unit 801 to on board control unit 804. On board control unit 804 is also in constant communication with custom application 409 as shown in FIG. 9. The readings taken by underwater unit 801 are combined with environmental data readings 408 (FIG. 4) to determine if the fishing conditions are good in that location. Both on board control unit 804 and underwater unit 801 are powered by on board power source 803, typically the battery. However, according to another embodiment of the present invention, a pier fishing can be performed with a power source 803 replaced with any type of 12 volt battery, the control unit 804 being placed above pier, and the underwater unit 801 being lowered by the user into the water manually to achieve a desired effect without necessity of having a boat.

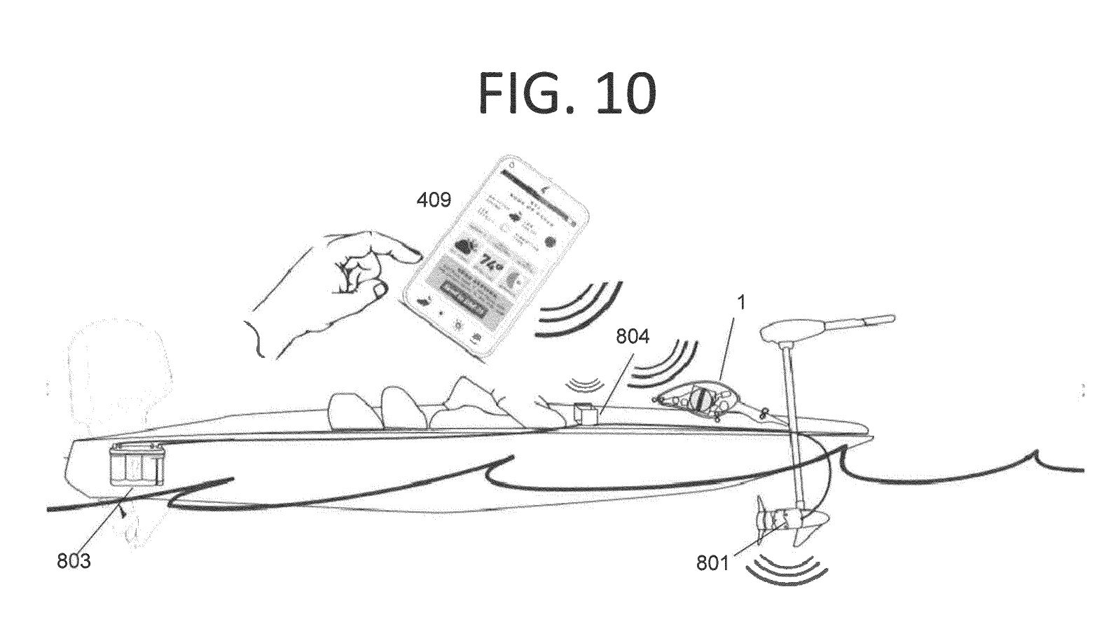

Once inner capsule 1 is brought on board, custom application 409 will then send to and receive data from inner capsule 1, while still being in communication with on board control unit 804, as shown in FIG. 10.

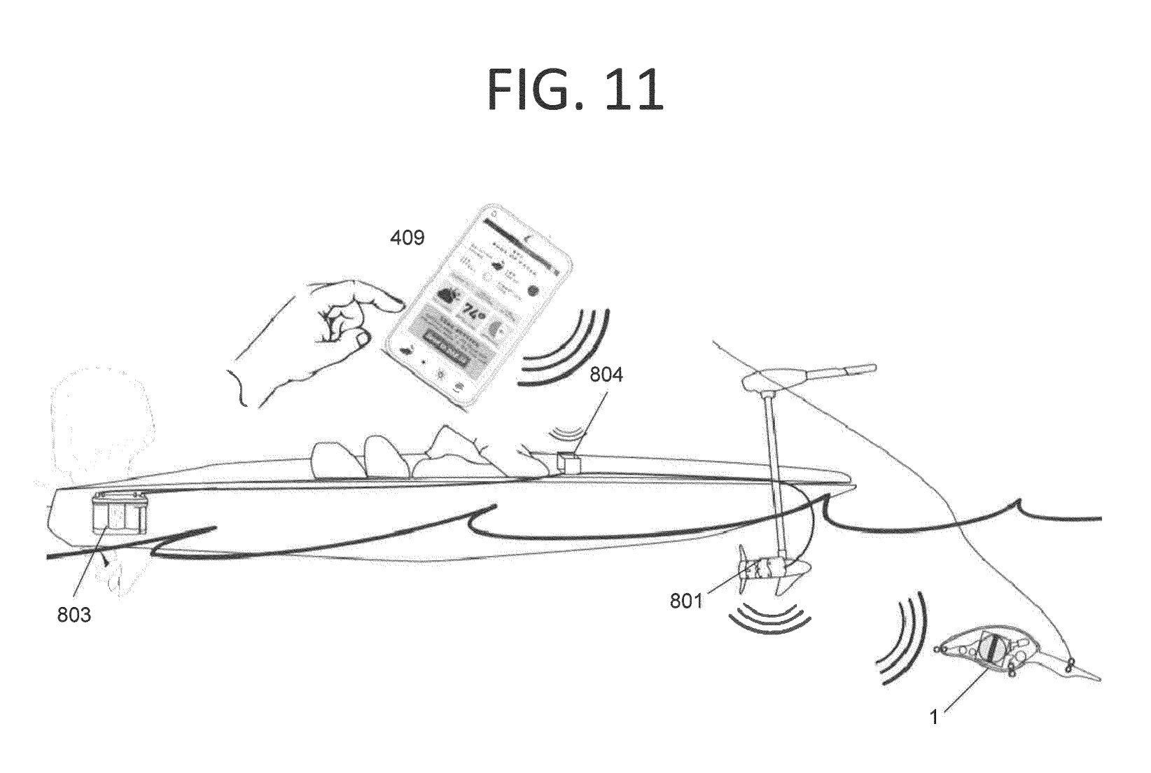

In certain applications, inner capsule 1 communicates with underwater unit 801 while submerged, as shown in FIG. 11. Underwater unit 801 relays the data collected from inner capsule 1, along with the data collected by underwater unit 801, to on board control unit 804. The user can then receive real time data from, and send real time commands to, inner capsule 1 as well as the board control unit 804.

In some of these embodiments, a tail chamber of apparatus 40 holds an RF “radio frequency” tag, WiFi component and/or blue tooth transmitter to communicate with top side on board computer, tablets, PDA and smart phones through custom application 409 suited for this particular function of programming, executing and reading certain environmental conditions of habitats of aquatic life and the reaction of species in salt and freshwater conditions. In such configurations, iOS, PC, Tablet, Notebook, Smartphone, PDA with RF tag or WiFi components, or blue tooth transmitter in NFC system integration (Near Field Communication) permit communications with the underwater device and on board controls.

In other embodiments, a headphone jack adapter is the functioning device that affects the control of the underwater observation device and give commands that executes color changing in the exterior capsule 50 and VSED's. Pitch control and variance also comes from commands from said adapter. An adapter is used in conjunction with iOS, tablet, notebook, PC, smart phone, PDA application and include different modes to control underwater device for specific tasks while underwater. Finger control on custom application 409 and push button tabs are the complete route of the way commands are executed. Different sounds, pitches, patterns and LED lights, patterns can be wirelessly uploaded to apparatus through application. This can also be done through micro, mini and full size USB jacks.

In still other embodiments, controller 10 in inner capsule 1 houses a proximity sensor embedded within controller 10 that senses when to add decibels to the pitch and when to lower the decibel. The proximity chip also controls the VSED feature of controlling color and intensity of VSED color choice at the time of observation. Detection of proximity of species in habitat environment determines the amount of electrical current powering controller 10, WiFi, NFC, and blue tooth chips through the automatic proximity sensor embedded within inner capsule 1.

In still other embodiments, a micro video chip sensitive transmitter is embedded inside inner capsule 1 or the underwater unit 801, and is capable of sending images to on-board equipment tablets, PC's, notebooks, iOS devices, PDA, smart phones, or navionic equipment that are running custom application 409.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

What is claimed is:

1. A multiple mode artificial fishing lure that simulates bait fish characteristics, said fishing lure comprising:
a main body portion having a waterproof inner capsule;
said waterproof inner capsule containing an electronic circuit to produce sounds to mimic bait fish and a vibration, said electronic circuit comprising:
a controller operationally coupled to:
a sound producing chip having pre-recorded bait fish sounds recorded thereon;
a speaker to broadcast said recorded sounds;
a sensor for detecting dynamic movements;
a power source for providing power to said components of said electronic circuit; and
at least one hook coupled to the main body;

2. The multiple mode artificial fishing lure of claim 1, further comprising:
a water detection sensor coupled to said electronic circuit, wherein said water detection sensor can also trigger said controller to broadcast said recorded sounds and to activate a vibration from said speaker.

3. The multiple mode artificial fishing lure of claim 1, further comprising:
at least one light coupled to said electronic circuit, wherein said light is activated by said controller.

4. The multiple mode artificial fishing lure of claim 3, further comprising:
a water detection sensor coupled to said electronic circuit, wherein said water detection sensor can also trigger said controller to broadcast said recorded sounds and to activate a vibration from said speaker.

5. A multiple mode artificial fishing lure that simulates bait fish characteristics, comprising:
a main body portion having a waterproof inner capsule, said waterproof inner capsule containing an electronic circuit to produce sounds to mimic bait fish and vibration, said electronic circuit comprising:
a controller programmed to broadcast said recorded sounds and to produce said vibrations, said controller operationally coupled to:
a sound producing chip having pre-recorded bait fish sounds recorded thereon;
a speaker to broadcast said recorded sounds, said speaker having capability of vibrating;
a sensor for detecting dynamic movements, wherein said dynamic movements trigger said controller to broadcast said recorded sounds and to activate said vibration of said speaker;
a power source for providing power to said components of the electronic circuit;
a water detection sensor coupled to said electronic circuit, wherein said water detection sensor can also trigger said controller to broadcast said recorded sounds and activate said vibration in said speaker;
at least one light coupled to said electronic circuit, wherein, said controller is programmed to selectively activate said light; and
at least one hook coupled to the main body;

6. The multiple mode artificial fishing lure of claim 5, wherein said controller is programmed to emit sound patterns such that bait fish sound is broadcast for a set period of time, then remains quiet for an equal period of time.

7. The multiple mode artificial fishing lure of claim 5, wherein said controller alters said light intensity and duration based on conditions of the fish habitat.
